(19) United States
(12) Patent Application Publication
(10) Pub. No.: US 2024/0402037 A1
(43) Pub. Date: Dec. 5, 2024

(54) EVALUATION OF IN-SERVICE BRIDGE BEAM CONDITION AND TESTING OF STRUCTURAL CAPACITY USING POINT CLOUD

(71) Applicant: UNIVERSITY OF MASSACHUSETTS, Boston, MA (US)

(72) Inventors: Simos Gerasimidis, Boston, MA (US); Chengbo Ai, Boston, MA (US); Aidan Provost, Boston, MA (US); Georgios Tzortzinis, Boston, MA (US)

(21) Appl. No.: 18/731,649

(22) Filed: Jun. 3, 2024

Related U.S. Application Data
(60) Provisional application No. 63/470,377, filed on Jun. 1, 2023.

(51) Int. Cl. G01M 5/00

(52) U.S. Cl. CPC G01M 5/0008; G01M 5/0033; G01M 5/0058

(57) ABSTRACT

Various examples are provided related to evaluation and testing of bridge beams. In one example, a method includes obtaining point cloud data for opposite sides of a bridge beam including registration objects affixed at defined locations; determining contour maps based upon the point cloud data; identifying thicknesses of the bridge beam from the contour maps; and determining failure load of the bridge beam based at least in part upon the thicknesses and the contour maps. The point cloud data can be aligned by course registration based upon the registration objects and subsequent fine registration based upon surface features of the scanned regions. In another example, a system can determine contour maps of a bridge beam based upon point cloud data for opposite sides of the bridge beam; identify thicknesses from the contour maps; and determine failure load of the bridge beam using the thicknesses and the contour maps.

### CROSS REFERENCE TO RELATED APPLICATIONS

This application claims priority to, and the benefit of, U.S. provisional application entitled “Evaluation of In-Service Bridge Beam Condition and Testing of Structural Capacity Using Point Cloud” having Ser. No. 63/470,377, filed Jun. 1, 2023, which is hereby incorporated by reference in its entirety.

### BACKGROUND

Assessing the condition of aging infrastructure has become one of the most prevalent challenges of our time. It is increasingly observed that a significant part of the bridge transportation network is in dire need of maintenance as it continues to deteriorate year by year. Among many of the causes for this aging, corrosion constitutes a common cause of damage and is associated with section loss in steel components of the superstructure. For bridge girders, the phenomenon is more intense close to the supports where malfunctioning expansion joints fail to prevent water from reaching the bearing area. The leaking water may contain high concentrations of chemicals employed to winterize the deck above, and if the leakage is sustained, it can ultimately affect the girder load bearing capacity.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a table illustrating examples of girder dimensions from Bridge A and Bridge B, in accordance with various embodiments of the present disclosure.

FIG. 2 includes images of the girder from Bridge A, in accordance with various embodiments of the present disclosure.

FIG. 3 illustrates an example of point cloud processing for thickness estimation and the analytical and computational capacity assessment, in accordance with various embodiments of the present disclosure.

FIGS. 4A-4D illustrate examples of thickness estimation based on ultrasonic thickness gauge and point cloud data, in accordance with various embodiments of the present disclosure.

FIG. 5 is a table illustrating examples of girder dimensions from Bridge A and Bridge B, in accordance with various embodiments of the present disclosure.

FIG. 6 includes images of deterioration condition of the girder from Bridge B, in accordance with various embodiments of the present disclosure.

FIGS. 7A and 7B illustrates a contour map from laser scanning of web thickness along the web of the girder from Bridge B, in accordance with various embodiments of the present disclosure.

FIG. 8 illustrates an experimental and instrumentation configuration of a laboratory setup, in accordance with various embodiments of the present disclosure.

FIGS. 9A and 9B illustrates examples of applied load versus vertical displacement and lateral deformation (or displacement) profile of the web, in accordance with various embodiments of the present disclosure.

FIG. 10 includes images of developed displacements at peak load, in accordance with various embodiments of the present disclosure.

FIG. 11 illustrates an example of stress-strain curves for steel, in accordance with various embodiments of the present disclosure.

FIG. 12 illustrates an example of a finite element model for simulations, in accordance with various embodiments of the present disclosure.

FIGS. 13A and 13B illustrate examples of experimental and numerical result comparison for applied load versus corroded end displacement and reaction force developed at the cross beam versus the recorded displacement at the same area, in accordance with various embodiments of the present disclosure.

FIGS. 14A and 14B illustrate an example of captured and numerically determined failure mode, in accordance with various embodiments of the present disclosure.

FIGS. 15A and 15B examples of parameters involved in the analytical evaluation process, in accordance with various embodiments of the present disclosure.

FIG. 16 illustrates an example of analytically captured failure load, in accordance with various embodiments of the present disclosure.

FIGS. 17A-17D illustrate examples of point-based alignment for multiple scan fusion, in accordance with various embodiments of the present disclosure.

FIG. 18 illustrates an example of misaligned data from two separate scans, in accordance with various embodiments of the present disclosure.

FIG. 19 illustrates an example of meshed beam web surfaces a bridge beam end, in accordance with various embodiments of the present disclosure.

FIG. 20 illustrates an example of thickness measurement, in accordance with various embodiments of the present disclosure.

FIG. 21 illustrates examples of a corrosion contour and corrosion heat map, in accordance with various embodiments of the present disclosure.

FIG. 22 is a schematic block diagram illustrating an example of a computing device that can be used for implementation of a bridge beam evaluator, in accordance with various embodiments of the present disclosure.

### DETAILED DESCRIPTION

Disclosed herein are examples related to evaluation and testing of bridge beams. Systems and methods using 3-D point cloud data are presented for evaluating bridge beam conditions and testing the structural capacity of the deteriorated bridge beam. Three-dimensional (3D) laser scanning can be used to evaluate deteriorated steel bridge girders due to corrosion. The data acquisition of the point cloud data can be achieved through a point cloud scanner (e.g., light detection and ranging (LIDAR) scanner, stereo vision cameras, structure from lighting-based sensors, etc.) following a customized scanning sequence and pattern. The data processing of the point cloud data can use rigorous point cloud registration and geometry measurements. The beam condition evaluation and structural capability testing can be achieved through interpretation of geometry measurements of the scanned bridge beams based on the existing bridge inspection manual or user inputs. Reference will now be made in detail to the description of the embodiments as illustrated in the drawings, wherein like reference numbers indicate like parts throughout the several views.

To assess the structural condition of corroded steel bridges, associated agencies require the documentation and quantification of the phenomenon. In most cases, inspectors have to overcome accessibility challenges and instrument readings of single point measurements to describe varying thicknesses over a planar surface, using mainly thickness gauges and calipers. Another challenge in this process is that the phenomenon of corrosion on steel members is topologically non uniform and highly random. Unavoidably, if this type of documentation is not combined with a plethora of measurements, it may not describe the member's condition adequately which makes it difficult to evaluate the structural condition of the member and ultimately of the bridge superstructure.

As an alternative, 3D laser scanning technology provides rapid 3-dimensional spatial data acquisition and has the potential to address the limitations of conventional inspection techniques. Terrestrial laser scanners (TLS), also referred to as terrestrial LiDAR (light detection and ranging) collect dense point clouds enabling a digital reconstruction of the actual surfaces. This capability enables the implementation of 3D scanners in numerous applications in engineering, ranging from the evaluation of a tunnel's deformation to the extraction of sidewalk inventory. In bridge engineering, point cloud data have been employed to measure deformation, to digitize the structure's geometry or for inspections.

The use of a laser scanner to estimate the vertical deflection of a bridge under load has been proposed. The obtained vertical displacements detected by TLS and by precise leveling were in the same range. A 3-point bending test of a concrete slab was also conducted to compare the displacements captured by TLS to the deflections estimated by a finite element model, and the observed difference was less than 5%. Moreover, a 4 m long steel beam was tested, and the maximum deflection recorded by TLS was within 1.6% of those measured directly by a linear displacement transducer. Laser scanning was also employed to examine whether vehicle impacts resulted to permanent deformations along a prestressed concrete bridge. The comparison between the struck bridge and a reference viaduct did not reveal significant displacements. A good agreement for the minimum under clearance magnitude estimation between laser scanners and a total station's output was obtained.

A laser scanner has been used to provide the as-built records for six historic timber bridges. A comparison between digital and traditional measurements resulted to a mean error of 1.01 mm to 2.02 mm. In addition, a medieval masonry bridge was scanned and modeled, while finite element analysis was performed to assess the as-built condition of a cast iron under-arch bridge constructed in 1851. An automated methodology has also been used to converse point clouds to a finite element model. In that study, a footbridge was modeled and assessed under design load. Moreover, a workflow was introduced to generate the geometry of bridges for computational analysis. A wrought iron bridge was scanned and numerically assessed under loading scenarios based on the AASHTO regulations. Laser scanning of a reinforced concrete bridge was performed to ultimately calibrate a computational model for structural condition assessment.

A methodology to automatically extract point cloud subsets of surfaces of structural components of concrete bridges was developed, providing elements for further processing to generate a 3D model of the structure. A cable stayed bridge was scanned to confirm the reliability of using TLS for Bridge Information Management (BrIM) and geometric Computer-Aided Design (CAD) model extraction. Laser scanning, photogrammetry and infrared scanning were compared for 3D geometric modeling of six concrete railway bridges. The obtained results demonstrated the superiority of the laser scanning approach. However, there is a lack of an accurate and efficient method for rapid bridge condition evaluation and bridge structural capacity testing by fully leveraging the advancement of 3D scanning technologies. To address these, a reliable structural capacity analysis needs a high-fidelity model for the bridge beam, or beam components, with extremely high accuracy, geometry features for in-service bridge beam or beam components need to fuse multi-run scanning data which is challenging due to the dimensions being scanned (e.g., large coverage, irregular surface shapes, etc.), and translating geometry features (e.g., thickness) into a structural capacity model is a non-trivial process.

For the inspection of damaged bridges, the RGB colors associated to the corresponding data points can be used to identify the crack pattern on concrete. Point clouds and image processing can be combined to automatically measure the orientation and the cracks dimensions. An automatic recognition method of surface damages related to mass loss can be used, while the identification and quantification of spalling defects that are larger than 3 mm in both depth and length can be enabled. For corrosion induced deterioration along steel members, coating images can be employed to detect rust defects based on a methodology which combines color image processing and the Fourier transform. Laser scanning and close-range photogrammetry can be combined to conduct surface analysis detecting corrosion.

To examine the residual capacity of corroded members, three naturally corroded truss beams were scanned and four-point bending tests conducted. The obtained point clouds were used to create finite element models with shell or solid elements which encapsulate the measured section loss. Moreover, an analytical expression for estimating the residual moment capacity was provided. A methodology was proposed to integrate the corrosion condition of scanned beams into beam elements for finite element analysis. First, the beam representation can be divided into slices along its longitudinal direction. In each slice, the basic geometrical properties (e.g., cross section area) can be calculated and assigned to each beam element of the finite element model discretization. Finally, a portable 3D scanner can be employed to create digital representations of actual corroded steel girders both in the laboratory and in the field. In addition to aging beams, laser scanning can also be used for geometry reconstruction and analysis of artificially deteriorated reinforcement steel bars, tensile coupons, and small plates. Although point cloud data has been explored for the detection and for the quantification of section loss due to corrosion, these estimations have not been validated, by comparing data obtained using different techniques, nor have 3D laser scanning data been used to improve estimates for bridge rating purposes.

The present study involves scanning and testing of naturally field corroded girders obtained from decommissioned bridges, showcasing the potential of the 3D laser scanning technology on an actual corroded girder. The investigation is categorized into three different phases. In Phase I, a methodology for mapping a section of a corroded steel girder is established and validated. In Phase II, a full-scale laboratory test of the naturally corroded rolled I-girder is conducted to obtain the failure load and mode. In Phase III, the experimentally obtained results can be used as a benchmark to assess capacity estimations derived from finite element modeling and closed form equations. Corrosion is taken into account using the methodology developed in Phase I, demonstrating the potential of 3D laser scanning technology for inspecting corroded steel bridges.

### Phase I: Mapping Corrosion Induced Section Loss in a Steel Girder Using 3D Laser Scanning

As a proof of concept, 3D laser scanning was used to measure thickness losses on steel girders which were naturally corroded. A girder from a decommissioned bridge which was transported to the structural engineering lab was used. A corroded planar part of the girder web was scanned and the obtained point clouds were post-processed to estimate the remaining material. Finally, a mapping method is developed which serves the purpose of inspecting corroded steel bridges.

Equipment. Measurements were collected employing a RIEGL VZ-2000 LiDAR. This instrument integrates three primary components: the LiDAR sensor, the precise positioning system, and the camera system. The LiDAR sensor is used to acquire the point cloud that generates up to 400,000 points/sec. The integrated precise positioning system (GPS/IMU) is used to acquire accurate coordinates from a global positioning system (GPS) and an inertial measurement unit (IMU). The camera system is used to capture video log images which are calibrated and integrated with the LiDAR sensor that captures high-resolution imagery.

In the field of 3D laser scanning two main technologies are found, laser scanners and structured laser scanners. While laser scanners operate by projecting a laser point onto the object and measuring its reflection, structured laser scanners project a pattern of light. Commercially available portable structured light scanners can provide up to sub-millimeter point accuracy. Due to the sensitivity to the lighting conditions, as well as limitations of the working distance, these instruments were not preferred in the current work.

A desktop computer with i7-7700 CPU at 3.60 GHz and 32 GB RAM memory was employed for post-processing of the acquired data. A discrete graphic card that is dedicated for 3D rendering is recommended for point cloud processing.

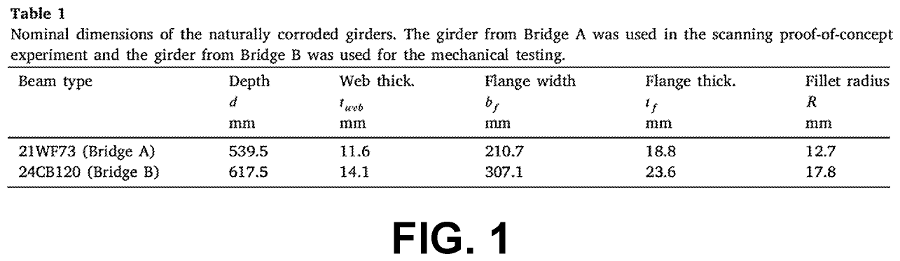

Data collection. The 3D laser scanning experiment was conducted with a naturally corroded steel girder which was acquired from a decommissioned bridge, referred as “Bridge A” in this disclosure, built in 1939 in the state of Massachusetts. The superstructure was comprised of rolled 53 cm deep WF beams spanning approximately 6.1 m over a single span. Table 1 shown in FIG. 1 provides minimal dimensions of the girder from Bridge A. Considering that the maximum clearance between the lower face of the deck and the stream bed did not exceed 2.4 m, the bridge was located in a high moisture environment. The reported extensive section loss due to corrosion may be attributed to stream flooding combined with moisture exposure.

To scan the web surface, the girder was placed in a simply supported condition in the structural laboratory. A unique scan was performed from each one of the two ground stations to capture both sides of the web. Each scan lasted approximately 5 minutes, capturing a 360° view of the field. The laser scanner provides the ability to perform scans without the use of a laptop or external storage device, by storing the acquiring data at an internal memory.

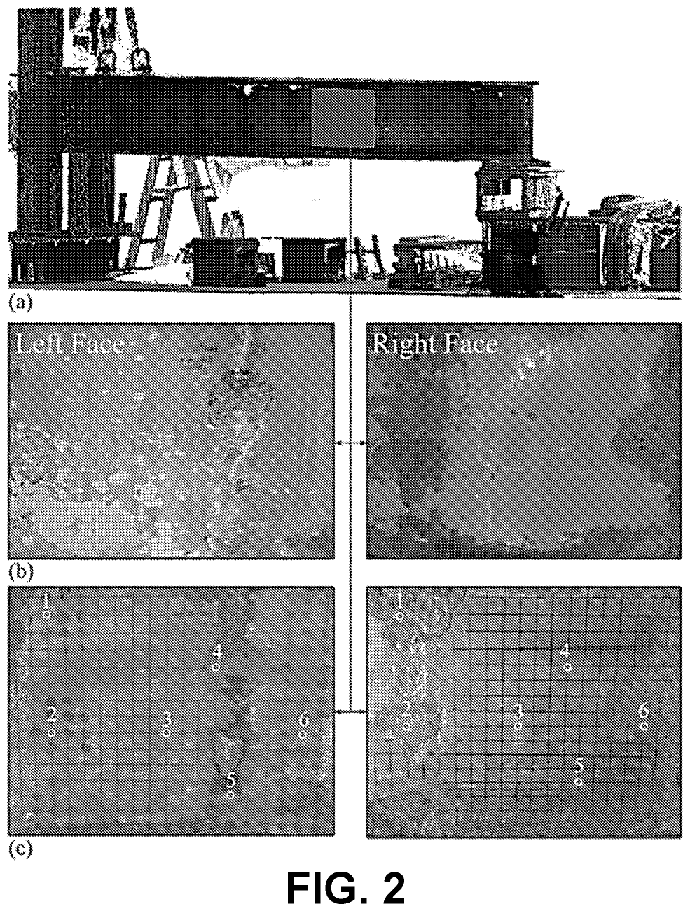

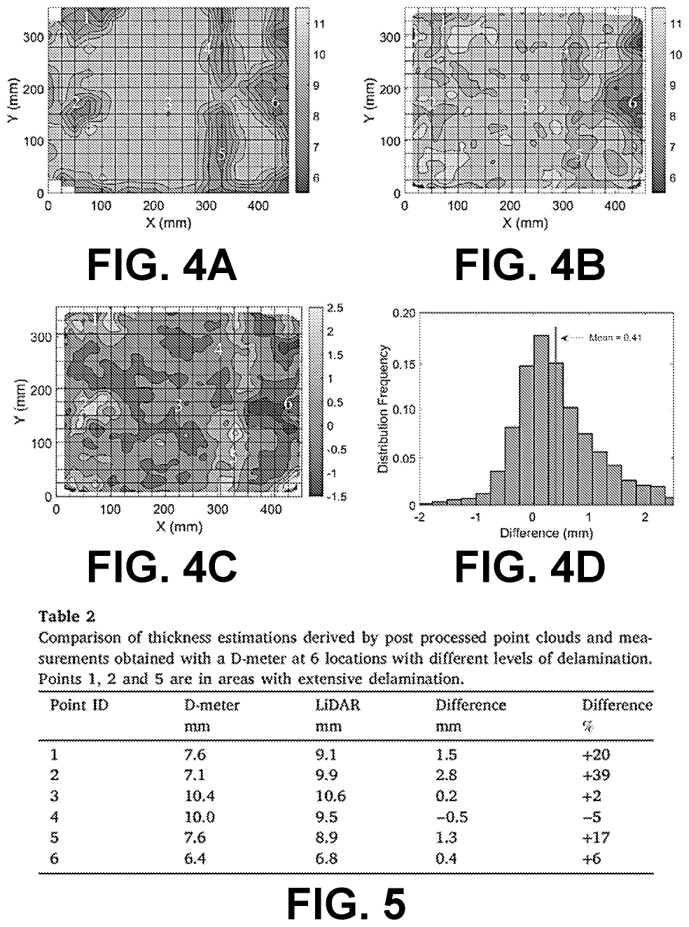

To resemble the actual challenges that inspectors have to face in the field, even though the whole beam was scanned, set specific criteria for the selection of the web area that would be used to evaluate the thickness estimations. In detail, the followings requirements should be satisfied:
The web region should contain mixed areas having intact and corroded regions.
The web region should contain mixed areas with and without coating.
The web region should have areas with steel delamination.
The web region should exhibit different levels of section loss.
   Based on these criteria, a rectangular web area with dimensions of 45.7 cm by 35.6 cm was selected close to midspan. FIG. 2 depicts its location as well as the actual condition of both web faces before and after mud, coating and rust were removed. Image (a) shows the scanned girder obtained from Bridge A, with the rectangular area selected for thickness measurement indicated. The lower images show left and right faces of the rectangular area (b) prior to the steel being exposed and (c) after exposure of the steel. Thickness estimations for points 1-6 are presented in FIG. 4B.

Post Processing. Following the points extraction from the scanner, various processing steps followed. Initially, to improve the workability of the obtained files, points capturing irrelevant objects were manually selected and removed. Making use of automated points cleaning, isolated points commonly found close to objects edges were erased. Then, non-coplanar reflective and corner points distributed across the lab were used to register the two point clouds in one local coordinate system. The procedure up to this point was carried out using the software CloudCompare.

Having registered the data from the two scan positions, a box expanding along both web faces and aligned with the web plane was created. Points which fell into its volume (the domain of interest) were isolated. The number of points along the web surface was determined based on two parameters: the angular resolution of the LiDAR (horizontal and vertical) and the distance from the measured surface. Initially, very dense meshes were acquired. However, based on preliminary comparison of the post-processed data, the density of the previously cleaned data is uniformly reduced from approximately 40 to 8 points per square cm, increasing their workability. A mesh was built and then smoothed for each web face based on Delaunay triangulation. Subsequently, one side acts as the reference and the other as the compared mesh. The distances between the vertices of the compared mesh with respect to the reference mesh were computed and the obtained values, which correspond to the thickness of the section, were extracted as a scalar field associated to the reference mesh's points.

In order to scale down the problem by reducing the number of the involved parameters from 4 (x coordinate, y coordinate, z coordinate, thickness) to 3 (x coordinate, y coordinate, thickness), a plane was fitted to the reference side. To avoid manually selecting points that may not reflect the best fitting plane, the least squares solution was preferred. The mesh is rotated in space to position the newly introduced plane parallel to the xy plane originally set by the laser scanner orientation, and the z coordinate of each point was replaced by the previously calculated corresponding thickness. The resulting x, y, z data were employed to create contour maps depicting the remaining material along the examined domain (see, e.g., FIG. 4B). This approach serves the needs of rating engineers who are interested in the remaining thickness magnitude instead of the condition of each web face separately.

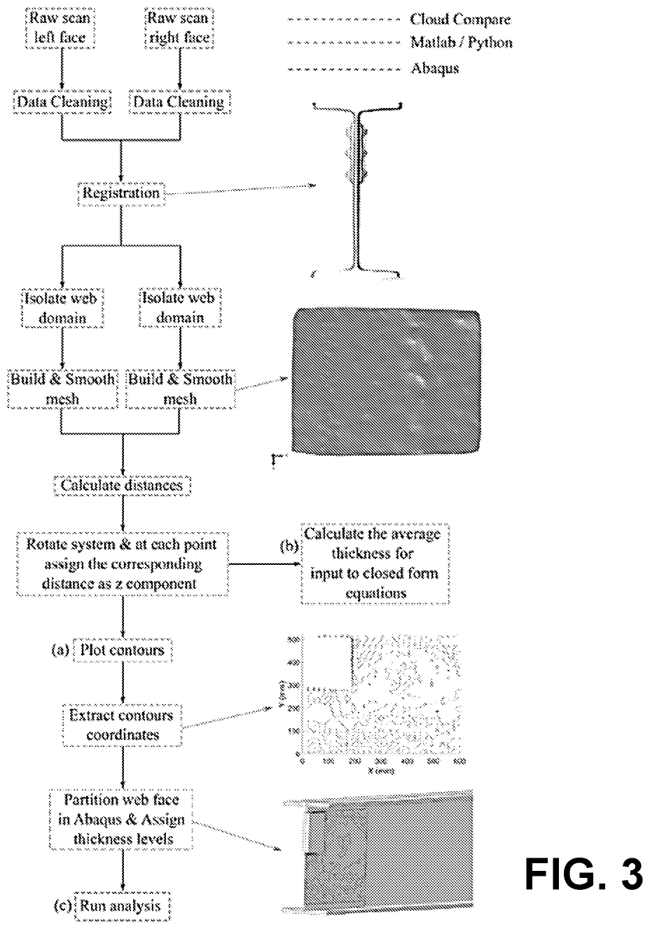

A visual representation of the method is provided in FIG. 3, which illustrates the point cloud processing for thickness estimation and the analytical and computational capacity assessment. As shown, raw scan data is acquired for both faces and the data is cleaned before registration. The data can be isolated in the web domain and used to build and smooth corresponding meshes. Distances can then be calculated from the mesh information. The meshes can be rotated and at each point the corresponding distances can be assigned as the z component. Contours of the surfaces can then be plotted, and contour coordinates extracted. The web face can be partitioned, and thickness levels assigned. The average thickness for the beam can also be calculated. The analysis can then be run.

Several variations of this methodology have also been considered. A machine learning tool, the support-vector machine algorithm, was used to choose the hyperplane that has the largest distance to the nearest data point of any of the two web faces (classes). The chosen hyperplane corresponds to the ideal web mid-surface. It is worth noting that a high order hyperplane could satisfactorily address beams with webs deviating from straightness. However, for the examined specimens, the selected approach provides similar results for significantly reduced computational cost.

Validation of 3D laser scanning. Detailed thickness measurements were performed in the selected region to determine the section loss using a thickness gauge (D-meter) with a resolution of 0.025 mm, and probe diameter of 12 mm by GE Inspection Technologies. This equipment is widely used by bridge inspectors in the field, and its operation is based on measuring the speed of an ultrasonic sound pulse which travels through the material. This process utilizes a coupling layer applied directly on the steel. Consequently, a hammer is usually employed in the field to locally reveal the metal at the positions where measurements are obtained. It is worth noting that usually limited measurements are taken by bridge inspectors. A grinder was used to remove loose scale and paint in the area where data points were taken with the D-meter.

Even though the thickness gauge is placed on a clean surface, a challenge of this method is varying instrument readings. A common aftermath of the uneven section loss is bumpy steel surfaces which can result in a significant variation of the measured thickness. To eliminate problems with local surface imperfections, and for reference to the thickness loss data, a grid with 2.5 cm spacing was drawn on both web faces, and combined measurements from both faces were obtained from 283 locations, as shown in the lower images (c) of FIG. 2.

Since the two approaches study the same area of the web, the acquired data points were used to create contours, which can be directly compared with the point clouds output. FIG. 4A shows a contour map illustrating the remaining thickness estimation based on ultrasonic thickness gauge and FIG. 4B shows a contour map illustrating the point cloud data. The displayed length and thickness values are in mm. In addition to the visual comparison, there is also interest in quantifying the variation between the two methodologies. A surface was constructed based on the data points of each contour, and their difference was calculated similarly to the procedure described in the “Post Processing” subsection. A contour presenting the obtained discrepancy (in mm) is found in FIG. 4C. Considering the thickness gauge output as a benchmark, positive and negative values denote that the post-processed point cloud data overestimates or underestimates the remaining thickness, respectively, from the benchmark. The distribution frequency of the discrepancy between the two surfaces is presented in FIG. 4D, with 56% of the corroded area captured with thickness variation less than +0.5 mm between the two methodologies. The mean difference is equal to 0.41 mm, which correspond to 3% of the intact web thickness.

To better interpret the comparison output, thickness estimations are presented in Table 2 of FIG. 5 at six representative locations (see FIGS. 2 and 4A-4C). Point 3, which represents the intact web condition, has been captured with just 2% discrepancy, showing an excellent agreement between the two methodologies. Point 6 is located in a region with section loss detected only at the right face of the web (see right image (c) of FIG. 2). The residual thickness estimation between the two methodologies varies only by 0.4 mm or 6%. Points 4 and 5 are located in the corroded area crossing vertically the left web face (see left image (c) of FIG. 2). At Point 4 where the beam surface is similar to Point 6, the thickness estimations by the two instruments vary only by 5%. On the other hand, it can be seen in the images (b) of FIG. 2 that points 1, 2 and 5 are located in areas where deposits and extensive delamination were covering the web faces when the specimen was scanned. With respect to the measurements obtained by the gauge over the exposed steel, the discrepancy along these locations rises up to 39%.

Considering that the beam was scanned in the as-received condition to meet challenges inspectors face in the field, the obtained results highlight the importance of a clean surface to avoid thickness overestimation due to the rust layers that will gradually detach from the web surface.

It is also worth noting, that the surface representation of the remaining web thickness based on the 283 thickness gauge data points provides reduced resolution compared to the LiDAR output which was meshed based on 6851 points. Consequently, the LiDAR may provide a more accurate representation of the actual web condition between the grid lines, which are spaced every 2.5 cm. Considering both the provided accuracy of the proposed methodology and shortcomings in current field measurements when using conventional acquisition techniques, 3D laser scanning shows significant potential for adoption in evaluation methods of corroded steel girders.

### Phase II: Laboratory Testing of a Naturally Corroded Girder

Specimen description. In this phase, a naturally corroded girder was scanned before it was subjected to full scale experimental testing to measure its failure load and mode. Preliminary finite element analysis revealed that the previously described and scanned specimen from Bridge A would most likely result in a flexural failure due to the extensive flange section loss. Therefore a girder from a second bridge, referred to as “Bridge B” in this disclosure, was utilized to experimentally explore the validity of the proposed methodology.

Bridge B was a three span steel bridge built in 1937 in the northern part of the Massachusetts. The design of the bridge contained continuous 24CB120 un-stiffened rolled girders (see Table 1 of FIG. 1). The two piers divided the total length into three equal spans of 18.5 m long each. The bridge was deconstructed in 2019 due to the critical condition of the deck, which contained a number of large holes through its surface. According to the inspection reports, the deck underside had widespread leakages, which potentially led to widespread surface rust with areas of heavy corrosion damage in the girders.

For testing, a girder was selected with localized areas of section loss exceeding 60% of the nominal thickness, above the support. For transportation purposes as well due to the limitations of the testing facility, the girder was cut in the field, and a 7.6 m long segment containing the corroded end was transported for testing in the structural laboratory.

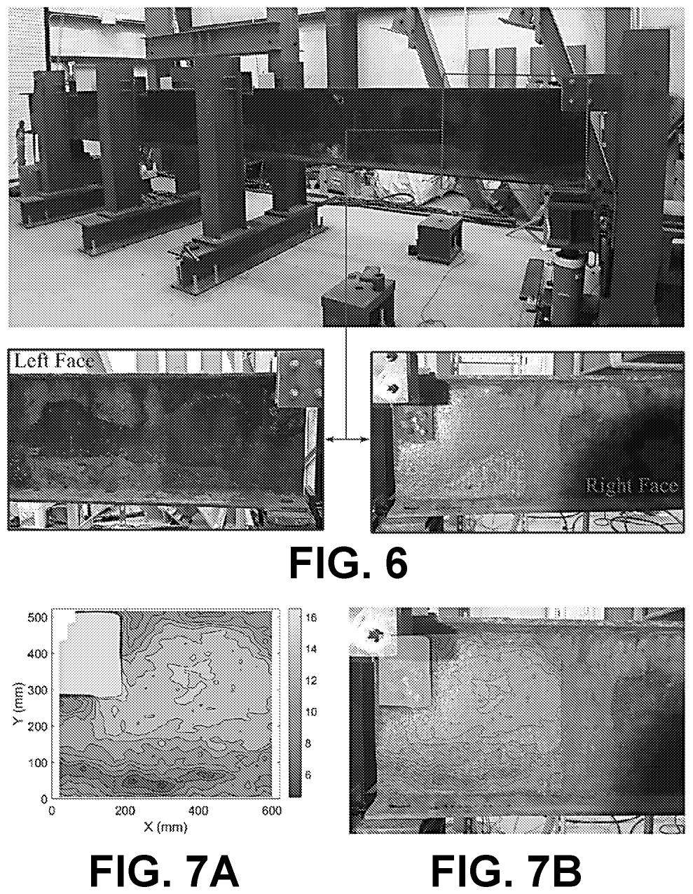

While in service, the beam ends were connected transversely with 30 cm deep C beam diaphragms attached to riveted plates located at the upper half of the webs. After the bridge demolition, the steel diaphragms were removed but the plates at both web faces remained on the girder. The images of FIG. 6 show deterioration condition of the specimen obtained from Bridge B. The girders were delivered with the sole plate welded to the bottom flange, which was later removed in the lab.

Section loss estimation. In contrast to the previously studied girder from Bridge A, no extensive delamination or deposits of mud are observed at the web faces of the girder from Bridge B. To estimate the remaining web thickness at the corroded web end, the same LiDAR equipment was utilized to scan both web faces. The acquired point clouds were processed following the procedure described in the Phase I section. The derived thickness contours are presented in FIG. 7A. The contour map from the laser scanning illustrates the remaining web thickness along the web of the tested specimen. In FIG. 7B, these colored thickness contours are overlaid or projected on the actual geometry of the specimen. Two areas with extensive section loss were observed. The first one is approximately 8.5 cm long by 3.0 cm high located below the remaining riveted plates. This topology is consistent with the common patterns of previous work, which revealed a high correlation between the diaphragm's existence (steel or concrete) and 100% web thickness reduction along the perimeter of diaphragm-web interface. The second area of distinct section loss extends longitudinally, directly above the bottom flange, with dimensions 47.0 cm long up to 10.0 cm high. Reduced thickness was also observed towards the top flange and along the inner edge of the remaining plates.

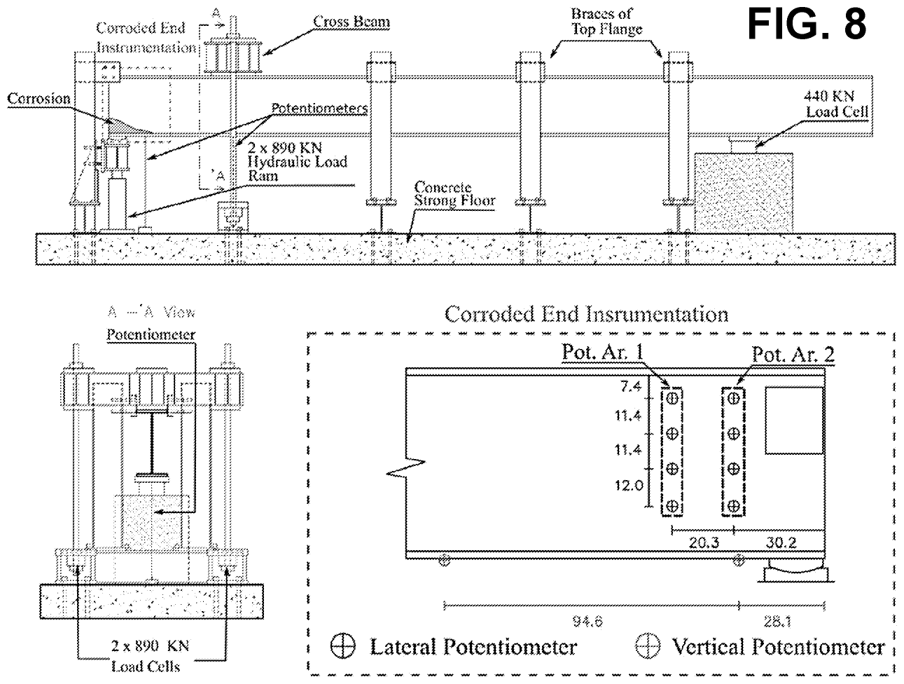

Laboratory testing—testing configuration. The laboratory setup was designed to generate high shear near the corroded end, and the girder was tested under a simply supported condition. FIG. 8 shows the experimental and instrumentation configuration. The illustrated values are in mm. An expansion bridge bearing obtained from another demolished bridge was placed below the corroded end accommodating rotational and translational displacements. The far end of the beam was supported on a 30.5 cm long rectangular steel plate, while the top flange was laterally supported to prevent lateral-torsional buckling from becoming the governing failure mode; in total, 4 pairs of lateral braces were placed along the length of the specimen.

Loading was applied using two 890 KN hydraulic jacks, located under the bearing of the tested end of the specimen. The jacks applied an upward vertical force simulating the reaction at the tested end. The force from each jack acted on a spreader beam that supported the bridge bearing on its bottom flange. A cross beam anchored to the laboratory strong floor by means of 4.6 cm threaded rods was used to hold the specimen down on a section located 1.2 m from the loaded end. The hold-down beam was fabricated using two separate W sections welded together to allow passage of a threaded rod that is anchored to the strong floor. For this study, the beam end closer to the applied load is referred to as the tested end while the other end is referred as the far end.

Laboratory testing—instrumentation. The specimen was instrumented to record load, displacements, and deformations at selected locations. Two 890 KN load cells were placed at the lower point of the threaded rods and a 445 KN load cell was used beneath the far end to record the reaction force. A pressure transducer was installed to measure pressure of the hydraulic fluid in the hose downstream of the hydraulic pump as a backup system to determine load.

Ten displacement potentiometers were used to record vertical as well as lateral deflections of the beam at selected locations during testing. Two of these potentiometers, with 254 mm measuring capacity each, were used to record vertical deflections of the beam during testing. The first instrument was installed on the outer face of the bottom flange beneath the cross beam to measure its upwards deflection. The second potentiometer was installed at the same flange 30.7 cm from the outer web edge of the tested end, or 21.8 cm from the center line. Eight potentiometers with capacity 102 mm each were used to measure the out of plane displacements of the web at the corroded end. These potentiometers were installed on a frame, forming an arrangement of two columns and four rows. This configuration was chosen to record two different sets of out of plane displacements taken over the height of the web. Due to the remaining riveted plates at the upper half of the web, both instrument arrays (Pot. Ar. 1 and Pot. Ar. 2 in FIG. 8) were placed beyond the inner edge of the corroded end bearing.

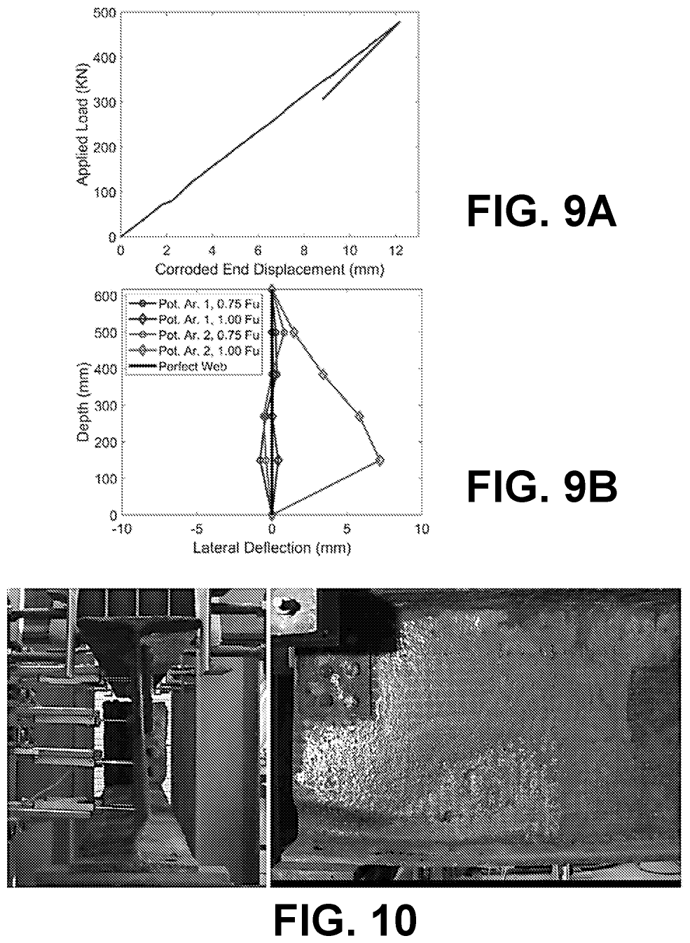

Experiment results. The beam failed by web buckling at an applied load of 478 KN, while the tested end's vertical displacement was 12.2 mm. FIG. 9A illustrates the applied load versus vertical displacement. Visualizing the data recorded by the two potentiometer arrays, FIG. 9B depicts the lateral deformation (or displacement) profile of the web as it was recorded, for two different loads, 0.75 and 1.0 Fᵤ, where Fᵤ is the peak applied load. Given that the prefect web line (at zero) represents the initial web position assuming no deviation from straightness prior to load application, a sudden failure is captured with instantly developed lateral displacements. This behavior complies with the sudden capacity drop observed in FIG. 9A.

FIG. 10 illustrates the developed displacements at peak load as they were captured from the two cameras recording the experimental procedure. A buckling wave was formed at the bottom part of the web with maximum magnitude at the outer web edge just above the bearing. The maximum lateral displacements profile was developed diagonally along the longitudinal axis of the beam, aligned to the region of the extensive section loss presented in FIG. 7B.

Phase III: Combining 3D Laser Scanning with FEM Computations and Analytical Solutions to Estimate the Capacity of Naturally Corroded Steel Girders

The capacity of the tested naturally corroded girder was estimated numerically using finite element analysis and compared to a simplified analytical approach developed previously. In both approaches, the condition of the corroded web was determined using the 3D laser scanning technique developed earlier in the disclosure. The measured load during the laboratory test of the specimen was used as a benchmark to evaluate the efficiency of point cloud data implementation to the computational and analytical estimations.

Finite element computations—section loss simulation. A methodology to enable the integration of point cloud data into a three dimensional geometrical model discretized with finite elements has been designed. Considering the intact web thickness as well as the corrosion condition of the specimen, the range can be divided between the maximum and the minimum calculated thickness in, e.g., 10 equally spaced thickness intervals, as illustrated in the example of FIG. 7A. The end points of each interval set the contour levels which join points with identical thickness. An application (e.g., a Matlab script) can be employed to extract the coordinates of the points that constitute each contour line as shown in FIG. 3, and the corresponding assigned thickness value. Subsequently, an application (e.g., a Python script) can be used to partition the web face of the simulated geometry (see FIG. 3) by connecting these points and ultimately creating a 2-dimensional representation such as the one presented in FIG. 7A. Finally, for each of the resulting regions enclosed by the contour lines, the application or script can automatically assign the level of the surrounding contour with the minimum value as uniform remaining thickness.

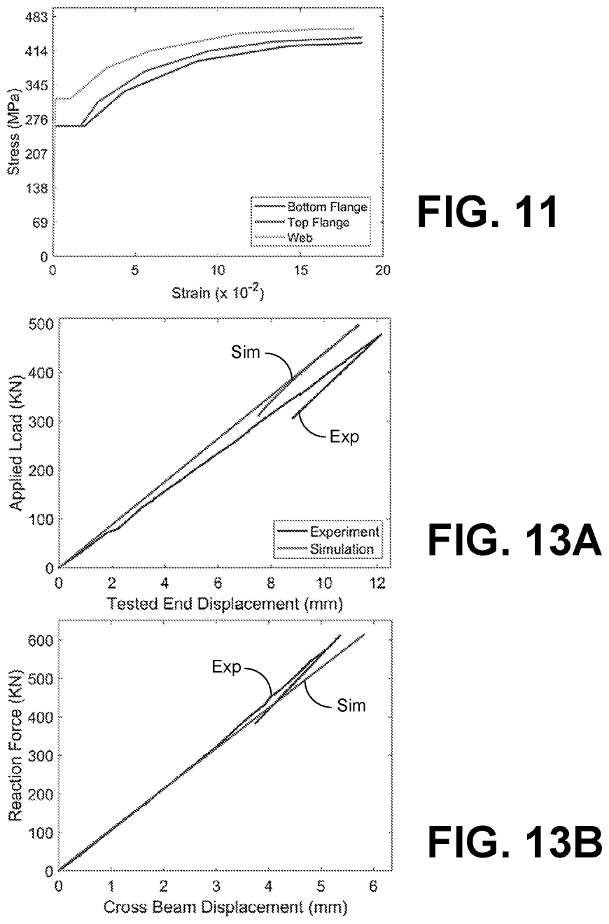

Finite element computations—material properties. The material properties of steel were determined through tensile testing. The number of coupon specimens along with the testing procedures followed the ASTM Standard E8 and stress-strain curves shown in FIG. 11, were obtained for coupons extracted from the web and the flanges. The differences in mechanical properties observed for material extracted from the web and flange may be attributed to the residual stresses.

Finite element computations—finite element model. The commercial finite element software ABAQUS was utilized for simulation and analysis of the laboratory experiment. Shell elements were used to approximate a three-dimensional continuous body with a surface at the middle of the section. The actual thickness was taken into account and assigned as a parameter to the corresponding elements. This approach has been validated in a previous work.

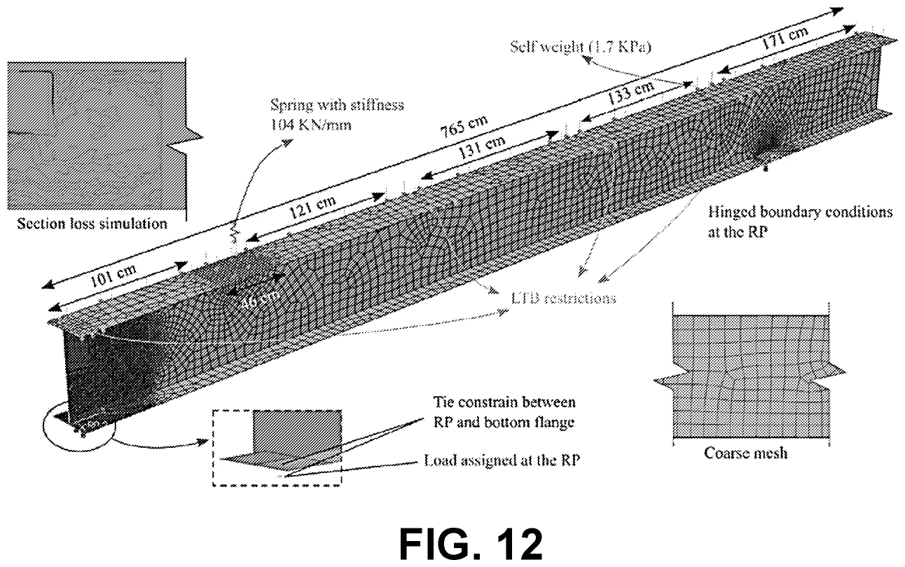

A sensitivity study on mesh size, type, and number of section points, was conducted and ultimately the four-node linear element S4R with five section points through the shell thickness was preferred, capturing bending and stretching effects. Following the study, both the corroded end and the bearing areas were meshed with element size of 1.3 cm. For computational efficiency, an adaptive mesh was applied for the rest of the beam which is discretized with elements sized up to 6.5 cm. FIG. 12 shows an example of a developed finite element model for simulating the conducted experiment. The deterioration condition of the corroded end was integrated in the model by partitioning the web region and assigning the thickness levels illustrated in the contour map of FIGS. 7A and 7B.

A particular aspect of the finite element model is the effect of the beam-rod assembly flexibility at the cross beam location. Due to the reaction force magnitude developed at the anchor rods, the cross beam is essentially a non-fixed boundary support for the corroded girder. FIGS. 13A and 13B compares experimental and numerical results for (a) applied load versus corroded end displacement and (b) reaction force developed at the cross beam versus the recorded displacement at the same area. The experimentally captured stiffness of the area (104 KN/mm), as captured in FIG. 13B was used to simulate this behavior. The constraints, derived by the anchor rods-cross beam system, were taken into account by introducing a spring, with its bottom end tied to the specimen's top flange and its top end clamped. The out of plane displacement along the top flange was also restrained at the locations of the cantilevered braces. Finally, both bearings were simulated as hinges.

A two-step analysis was carried out to simulate the self-weight as well as the incrementally applied load. During the first step, a quasistatic analysis was performed to include the effect of self-weight applied as uniform pressure along the top flange. Riks analysis subsequently follows to capture the failure as well as the post buckling behavior of the specimen under the applied load. To capture instability phenomena, a geometric nonlinear solution can be applied accounting for geometric imperfections. This has been achieved by initially conducting a buckling eigenvalue analysis, and the first eigenmode was introduced as an initial geometric imperfection for the quasi-static analysis. Since no deviation from straightness was observed at the pre-testing condition of the web, the amplitude of the first eigenmode was scaled to ten percent of the intact web thickness. Finally, operation of the hydraulic jacks was idealized as a concentrated force applied upwards at the hinge located below the tested end.

Finite element computations—numerical results. The applied load-vertical displacement relationship is presented in FIGS. 13A and 13B, which depicts a good agreement between the numerical and the experimental results. Regarding the peak load, the numerical model predicts failure at 497.7 KN of applied load, while the experimental value is 478.0 KN (overestimated by 4.1%). The observed discrepancy between the experimentally and numerically captured stiffness may be attributed to one main cause. Specifically, in-service loading may have resulted in residual stresses along areas of extensive section loss, causing local yielding during loading.

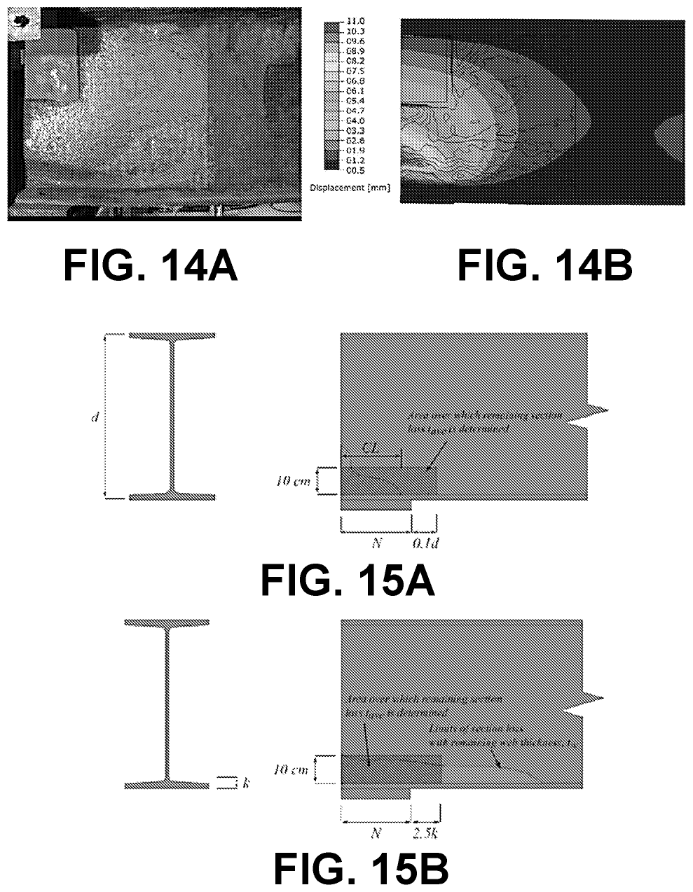

FIG. 14A presents the failure mode as it was captured by the video camera recording the experimental procedure. The thickness contour map is projected on the specimen after the buckling failure. In FIG. 14A the section loss contours are projected on the failed specimen, while FIG. 14B presents the numerically obtained failure mode with contours illustrating the lateral displacement profile. The thickness contour map is projected on the displacement contours obtained from the finite element simulation. In both cases, large displacements were captured approximately in the same location. Observation reveals that the failure mode was also satisfactorily captured. It is also worth noting that the section loss topology defined the displacements at failure. From this analysis, it can be seen that the 3D laser scanning procedure provides an accurate framework for the estimation of the capacity of corroded girders.

Analytical evaluation. According to the Massachusetts DOT (MassDOT) Bridge Inspection Handbook the live-load carrying capacity of bridges should be evaluated on a decade-basis unless concern occurs due to the critical condition of an asset. In that case, the inspectors can warrant a load rating request. In the state of Massachusetts, the remaining bearing capacity for aging steel bridges with deteriorated ends is estimated by provisions included in the MassDOT LRFD Bridge Manual. The rating procedures contained in MassDOT LRFD Bridge Manual are based on approximate closed form equations that only use a single value of remaining web thickness to account for corrosion deterioration present at beam ends. To estimate the remaining web thickness, inspectors perform point measurements in the area of interest, typically the corroded end region. Given that section loss is not uniform in the area of deterioration, the representative points of measurements currently depend on the inspector's judgment.

To improve the reliability and efficiency of the load rating procedures, closed form equations were developed for the capacity assessment of corroded girder ends based on the results of comprehensive finite element simulations. The closed form expression depends on the geometric characteristics of the girder. By taking into account the negligible web deviation from straightness, which in general does not exceed 10% of the intact web thickness, as well as the N/d ratio, where N denotes the bearing length and d is the beam depth, the bearing capacity can be calculated by:

$${R}_{n} = [ 0.6 \sqrt{{EF}_{y} {t}_{f}} {{t}_{ave}}^{1.5} + {0.24}^{( \frac{0.33 d}{N} )} ( \frac{4 N}{d} ) - 0.2 ) \frac{\sqrt{{EF}_{y} {t}_{f}}}{{t}_{f}^{1.5}} {{t}_{ave}}^{3} ] {( \frac{CL}{N + 0.1 d} )}^{0.15} \qquad ( 1 )$$

where, E is the Young's Modulus, F_{y} is the steel yield stress, and CL is the length of the corroded region within the bottom part of the web bound by a rectangle with a base equal to N+0.1d and a 10 cm height. FIG. 15A illustrated the parameters involved in the analytical evaluation process. Finally, tₐᵥₑ denotes the average remaining web thickness calculated according to.

$${t}_{ave} = \frac{( N + 0.1 d - H ) * {t}_{w}}{N + 0.1 d} \qquad ( 2 )$$

where H is the length of holes (if present) within the control rectangular area, and t_{w} is the remaining web thickness.

According to the MassDOT LRFD Bridge Manual, the following equations are used to estimate the remaining capacity of corroded beam ends based on governing failure mode. Considering the N/d ratio as well as the overhang length, the nominal resistance of the end is calculated on the basis of its yielding capacity as:

$${R}_{n , yield} = {f}_{y} {t}_{ave} ( 2.5 k + N ) \qquad ( 3 )$$

and its crippling capacity is based on:

$${R}_{n , crip} = 0.4 {t}_{ave}^{2} [ 1 + ( \frac{4 ( N - H )}{d} - 0.2 ) {( \frac{{t}_{ave}}{{t}_{f}} )}^{1.5} ] \sqrt{\frac{{EF}_{y} {t}_{f}}{{t}_{ave}}} \qquad ( 4 )$$

where k denotes the distance from outer face of the flange to web toe fillet. In this case tₐᵥₑ is estimated within the bottom region of the web bound by a rectangle with a base equal to N+2.5k and a 10 cm height as:

$${t}_{ave} = \frac{( N + 2.5 k - H ) * {t}_{w}}{N + 2.5 k} \qquad ( 5 )$$

where, H is the hole's length (if present) and t_{w} is the remaining thickness within this rectangle. FIG. 15B illustrated the parameters involved in the analytical evaluation process. The corrosion condition of the beam is taken into account with the value of the remaining thickness t_{w}.

For the current girder, due to the absence of holes (H=0), tₐᵥₑ equals to t_{w} both in Eqs. (2) and (5). For the particular specimen and by averaging the scanned cloud data on the areas of interest as defined by the two different specifications (10 cm by N+0.1d or 10 cm by N+2.5k), the t_{w} for the method using Eq. (2) is 8.5 mm and the t_{w} for the method using Eq. (5) is 8.4 mm. Using these values in Eqs. (1) and (4), would result to capacities of 558 kN for the method using Eq. (2) and 412 kN for the method using Eq. (5) showing a clear discrepancy between the capacity predictions and a measured capacity of 478 kN during the test.

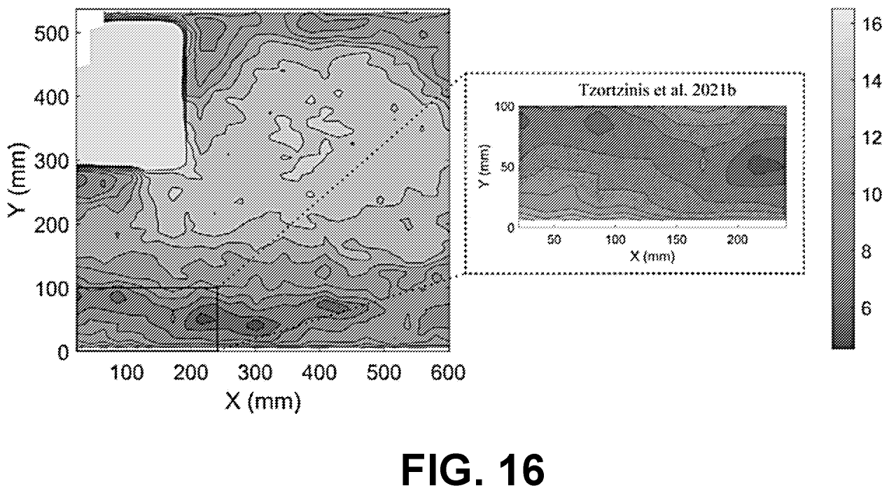

The source of this difference between the predicted values and the experimentally obtained capacity may be attributed to the simplistic definition of the parameter t_{w}. One can expect that by scanning a corroded area and by averaging the measured values within this area would lead to a more accurate prediction of the capacity of the beam, but in reality the non-uniformity of the corrosion must be taken into account for a correct prediction. For the specimen under study, the average thickness of 8.5 mm for the method using Eq. (2) is a source for a significant overestimation of the predicted capacity, because the nonuniformity of corrosion is dictating the capacity. The capacity is governed by buckling of a sub-region within the 10 cm by N+0.1d area of interest in which the remaining thickness is less than the average of the area of interest. This would mean that in case a laser scanner is to be used to obtain measurements for predicting the capacity of corroded ends, a calculation of the remaining thickness in the 10 cm by N+0.1d area by averaging the measurements is a faulty calculation. In reality, this calculation needs to account for the non-uniformity of the corroded area and depending on the level of non-uniformity, perform a weighted average calculation. In this case, if only the lower 76% of the measurements is used, the predicted capacity is 478 KN which corresponds to the experimental value. As illustrated in FIG. 16, the failure load can be analytically captured by calculating the average thickness of points (dots) located manly along the diagonal domain which governed the failure mode.

On the other hand, the under-prediction of the current method using Eq. (5) may be attributed to a significantly more conservative approach which also fails to capture the effect of non-uniform thicknesses on strength. Using this method for this particular case, the prediction was under the experimental value which is considered safe. The observed behavior cannot be attributed to the accuracy of the method, but to the overall conservative tendency, previously demonstrated both experimentally and computationally.

Regarding the use of laser scanning measurements with current or proposed analytical calculations, the obtained results provide evidence that there should be significant attention and more research on the calculation of the t_{w}. A weighted average method can be developed to account for the non-uniformity of the corrosion. In terms of today's practice of obtaining limited values of the remaining material, the strategy of most inspectors to obtain values at the worst locations (lowest values of remaining materials) seems to be very important and should continue to be followed.

The reliability and the efficiency of 3D laser scanning was validated as a technology for bridge inspections. LiDARs can address the shortcomings of conventional data acquisition techniques while at the same time abolish the sensitivity of ultrasonic thickness gauges along bumpy surfaces. Thickness estimations from 3D laser scanning were verified, and subsequently employed for capacity estimations. The proposed automated procedure can enable engineers to create finite element models which encapsulate the exact corrosion condition of damaged girders. This methodology offers a game changing tool for dealing with the uncertainty that usually comes along with the analytical evaluation of beams presenting varying levels of corrosion-induced thickness losses, which currently results in conservative estimates of remaining capacity.

### In-Service Beam Evaluation

Scanning Hardware. The proposed methodology takes general point cloud data as input. It is independent of the mechanism of the point cloud data acquisition as long as the point cloud data contains x, y, and z coordinates. The inclusion of intensity values will improve accuracy, but it is not essential. Examples of the hardware include, e.g., 3-D scanners, such as LiDAR, stereo vision cameras, structured light-based sensors, etc.

Scanning Protocol. For scanning in-service beams or beam components, a generalized scanning protocol was developed to accommodate different beam or beam component configurations and to facilitate multi-run point cloud data fusion (e.g., the embodiments of beam thickness measurement). The protocol includes a designed scanning path and sequence and a point cloud data registration scheme based on the availability of the calibration objects.

The scanning path and/or sequence can depend on the scanning devices and the configuration of the bridge structure. To obtain the best performance, the scanning sequence can start with no scanning angle on the most desired area of interest. For beam ends, this can be the area of the web at the beam end above the bearing. For example, this area can be approximately 4 inches high with a length dependent on individual beam parameters. For measuring capacity, this area is important. For a corrosion/deterioration profile for the entire beam end, the entire height of the web should be captured, not just the area of the web at the beam end.

Point Cloud Alignment. When scanning in-service beams or beam components with the need for multi-scan fusion, an overlapping region is captured in the different scans. Both point-based and surface-based alignments can be used to improve the disclosed methodology.

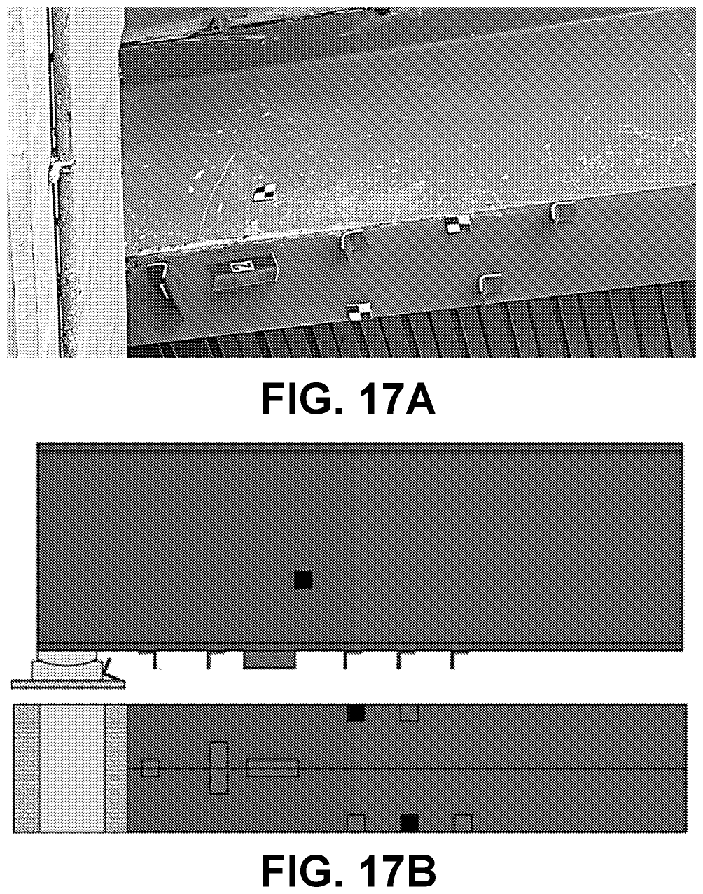

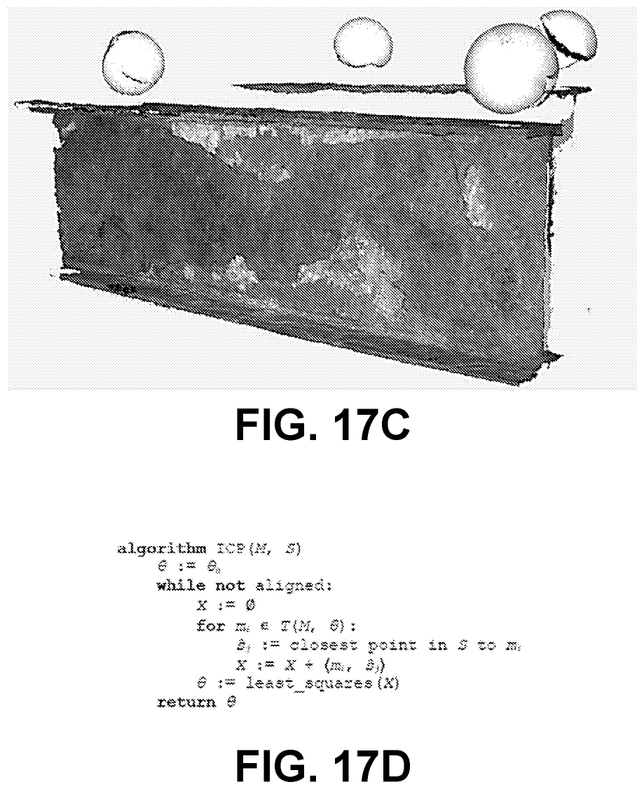

A point-based alignment, serving as a coarse registration, can first be applied based on a special placement of registration objects. For example, an alignment can utilize one or more 2×2 inch fiberglass angles with sharp block letters and/or one or more 2×2 inch square checkerboards to ensure there are several points for registration. Another example of such an alignment can utilize 4-inch diameter, mat-finished spherical objects. Sample configurations for point-based alignment are illustrated in FIGS. 17A-17C. FIG. 17A is an image showing a combination of registration objects attached to a bridge beam. These registration objects are staggered in space to avoid misalignment or alignment skew. FIG. 17B includes side and bottom views illustrating the placement of the registration objects. FIG. 17C illustrates an example of a point-based alignment configuration including white spherical objects for registration. A plurality of locations (e.g., at least 4 common points) can be chosen by a user to bring two scans together. These 4 points are shared by both scans and should not be present in the same plane as one another to successfully achieve the point-based alignment. The registration can be achieved by solving a least-squares fitting problem using, e.g., SVD.

A surface-based alignment, serving as a fine registration, can then be applied based on features of the common region captured by the different scans. An example of the common region includes the concrete abutment or pier cap underneath the beam or beam components. The alignment can be achieved by identifying and aligning the common features captured from the common region in different scans automatically and iteratively. An alignment algorithm such as, e.g., iterative closest point (ICP) can be used. FIG. 17D illustrates an example of an ICP algorithm. The algorithm can perform rigid registration in an iterative fashion by alternating the step of finding the closest point in one scan for every point in another scan given a rigid transportation matrix and the step of finding the best rigid transportation matrix for the given correspondences. The transformation matrix can be obtained by solving a least square problem as in the coarse alignment.

Data Processing—data import. The data import includes transfer of the scanned point clouds (in any stored format) from the scanning devices to a storage repository using a universally recognizable data container and alignment of the difference scans into the same global coordinate system.

Data transfer. Several point cloud file formats can be used by different scanning devices, including American Society for Photogrammetry and Remote Sensing (ASPRS) LAS format, Point Cloud Library (PCL) PTS formats, or comma separated value (CSV) format. To expedite the subsequent data processing speed and facilitate fast data retrieval for large point clouds, the imported data can be universally converted into, e.g., an Octree data structure or other appropriate data structure.

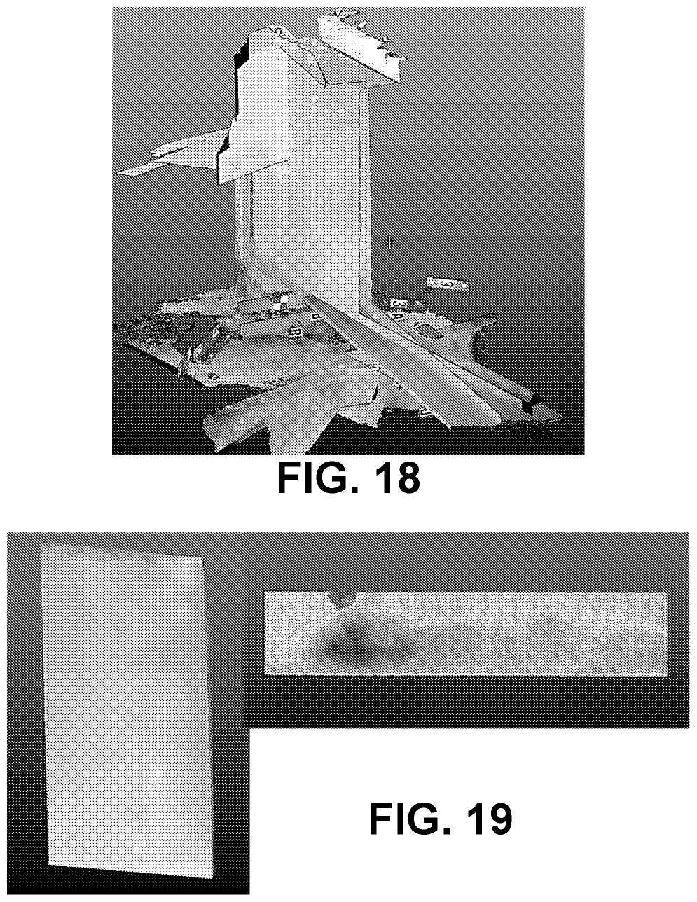

Coordinate Alignment: In the raw scanned data, there are several opportunities for the aligned or shared coordinate system to be skewed or tilted on the x, y, and z axes. Having a high-fidelity alignment allows for greater quantitative and qualitative results. Even a slight error in alignment can cause a larger error in the thickness estimation for the deteriorated end. Sequentially applying both coarse and fine alignments can achieve the best accuracy for merging multiple scans. However, due to the different configurations of the bridge structure, the placement of calibration objects for point-based alignment may not always be possible. In those cases, surface-based alignment can be applied as the sole step to align multiple scans. FIG. 18 illustrates an example of misaligned data from two separate scans.

Data Processing—point cloud meshing. As the imported, scanned data is only a set of unorganized points, a meshing process is needed to cluster meaningful, physical entities for the subsequent geometry measurements. Point cloud meshing can be achieved in different ways. For example, the meshing process can utilize Delaunay triangulation. After the triangulation, the elements (i.e., irregular triangles) that render poor aspect ratios or large angle distortions can be smoothed or merged into a larger element. FIG. 19 shows an example of the meshed beam web surface of both sides of a bridge beam end.

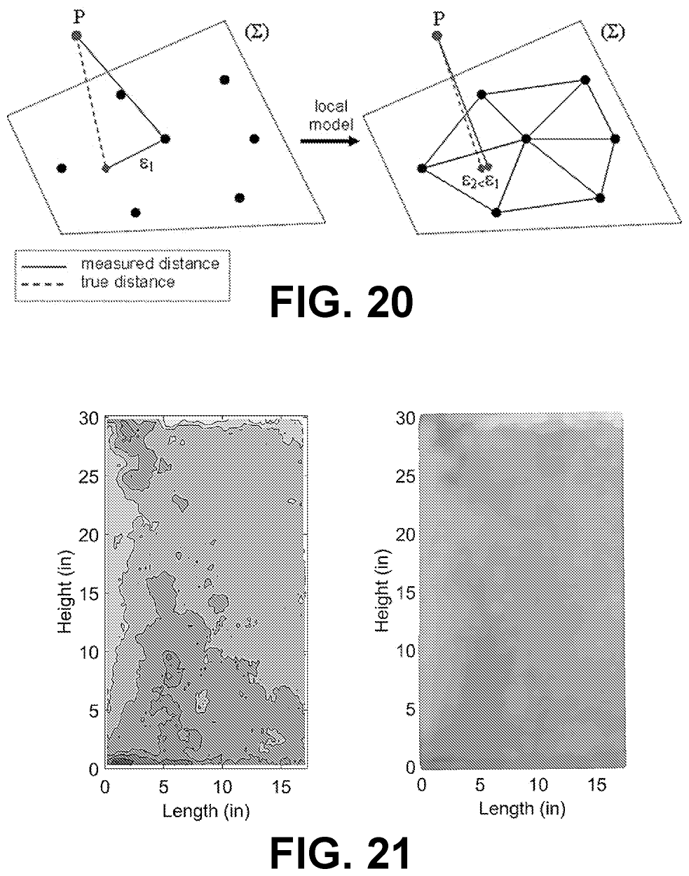

Data Processing—geometry measurement. Bridge beam or beam components comprise different geometry features and properties that lead to different representations of beam conditions and/or structural capacities. Some of the bridge beam geometries include, e.g., the thickness of the beam, the width, slope, thickness of the flange, etc. A sample of these geometry measurements can be the thickness measurement at the beam end. The way thickness is measured using point clouds is through computing the distance between points within the reference surface (i.e., either raw point cloud data corresponding to one beam side or the vertices of the meshed surface of the beam side) and the meshed surface of the other beam. Thickness between two meshed surfaces can be defined as a modified nearest neighbor distance within the meshed triangular network. FIG. 20 illustrates an example of the principle of the thickness measurement, where P represents a point from one side of the beam and the surface represents the meshed surface of the other side of the beam. The modified nearest neighbor distance can introduce a much smaller error, as the distance is computed between point P and the nearest facet in the mesh instead of the nearest single point. The use of principal component analysis (PCA) can improve the accuracy of surface correspondence, and provide the reference for projecting the point-to-surface distance along the normal direction of the surfaces.

Data Interpretation—corrosion severity. A method has been created where corrosion severity is presented in two different ways, each of which has different uses. The first presentation is a heat map that is dependent on thickness or “distance” measurements exported from the registration. The heat map allows for exact thickness measurements to be isolated for the millions of points gathered in the scans. This can assist with visualizing unique section loss like pitting or perforations. The second presentation provides corrosion severity through contour maps. The thickness is generalized and separated into levels of section loss. This allows for a generic corrosion pattern and a critical section loss area to be identified. Additionally, these contours can be used for modeling, such as a Finite Element Analysis model, and to identify common corrosion patterns and larger areas of major section loss. It has been found that the combination of these two visualizations of corrosion severity paints the whole picture of the deterioration at a beam end and provides vast data independently and when they are presented together. FIG. 21 shows an example of a corrosion contour (left) and corrosion heat map (right).

Data Interpretation—average thickness measurement. The resulting heat maps generated from the process are representative of the critical section loss area of the beam. Each data point contains the thickness measurements for a given location. Taking the average remaining web thickness of the beam to be the average thickness over the calculated critical section loss area, which can be found in coordination with the MassDOT bridge manual. If stiffeners or diaphragms are present in this area, the thickness that they add is removed from this calculation. Additionally, if there is significant delamination due to rust and paint protruding, these areas are also omitted for the purposes of calculating as close to the true thickness as possible.

Interpretation—capacity estimation. The scanning results can be through capacity estimation of a deteriorated beam via the previously presented equations and the MassDOT Bridge Manual. This procedure uses equations dependent upon individual beam specifications and characteristics. Additionally, the capacity is dependent on the average thickness measurement discussed above and upon web deviation, which is an imperfection present in the in-situ beam.

A typical bridge inspection report includes a text description of the corrosion induced damages. This description is usually supplemented with sketches and occasionally with photographs. Pictures may provide an excellent overview of the extent of damage, while sketches of varying levels of detail include the locations of usually a unique or two point measurements. On the other hand, the development of thickness contours based on 3D laser scanning techniques allows better capturing of the remaining thickness field efficiently and accurately. The provided methodology not only captures the corrosion characteristics with remarkable accuracy, but it also enables the quantification of section loss evolution in time if measurements from different periodic time intervals are compared.

It is worth noting, that the proposed methodology can be applied to any type of point cloud regardless of the instrument or method by which it was created. During the last years, many DOTs in the country have explored or even introduced the Unmanned Aerial Vehicles (UAVs) for visual inspection of bridges. UAVs implementation decreases the number of inspectors, speeds up the process and increases the accessibility to bridge components, while at the same time prevents the inspectors exposure to danger. Given the rapidly improved accuracy and precision specification of portable LiDARs, data can be also collected by aerial scanners mounted on drones, combining the advantages of both technologies.

Regarding the portability of the equipment, the employed scanner of this disclosure is a terrestrial LiDAR with weight that exceeds 9 kg. Point clouds are captured on both sides of the web limiting the use of this instrument to relatively accessible field conditions. Consequently, scanning in the field can be performed from a man bucket or using an unmanned vehicle. Under these conditions, the methodology can provide more objective and accurate thickness estimations in a much shorter time, when compared to distinct point measurements. In addition, the rapid improvement of LiDARs can make this technology much more accessible and implementable.

While cleaning the steel surfaces prior to scanning was presented, this may not be considered an additional work task for inspectors, given that a hammer is currently used to expose the steel for thickness measurements obtained with the conventional methods. The use of another tool can be introduced to enable the cleaning of a larger surface.

Currently, providing thickness input for the analytical provisions utilizes data manipulation that can last approximately one to two hours, depending on the file size. In three to four additional hours, capacity estimation from a finite element model can be obtained, making use of the automated procedure and scripts. This time can be further reduced through experience over time, improved processing capabilities or more automated procedures.

In the examples presented here, a naturally corroded beam from a decommissioned bridge in MA was scanned and the obtained point clouds were processed to determine the remaining material distribution at part of the web. After rust and coating removal, an ultrasonic thickness gauge which is common practice in today's inspection techniques, was also used. Bumpy steel surfaces and steel delamination hindered data acquisition or resulted in optimistic thickness estimations for the thickness gauge and the laser scanner, respectively. Thickness estimations were varying between 2% and 39% for areas with coating and heavy delamination. However, scanning from stationary points was conducted under laboratory conditions. The hindering effect of field conditions on data collection and quality may be improved, when a laser scanner is located on a man bucket or mounted on a drone. The overall performance of the developed methodology can potentially be improved with the use of industrial laser scanners which provide superior accuracy and precision.

Contours were chosen as a two-dimensional representation of the remaining thickness profile along the deteriorated area. This approach is easily processed from inspectors and engineers, it provides an overall description of the examined area, and it can be integrated in the inspection reports to upgrade the corrosion mapping. Moreover, the developed methodology could be used to explore the evolution of section loss in time.

Post processed point cloud data can be used for the assessment of the remaining capacity of deteriorated beam ends. A numerical study included the creation of computational meshes which integrate the exact condition of corroded girders. This approach was validated with full scale experimental testing of a naturally corroded girder. Comparison of numerically and experimentally obtained results provided credibility to the proposed automated methodology, since the failure load of the simulated specimen was captured with an error of 4.1%.

The analytical provisions consider the corrosion condition of a steel girder by integrating a unique thickness value representative of the remaining material above the support. Given the non-uniformity of corrosion phenomenon, the LiDAR implementation enabled the investigation of the physical meaning of the thickness which analytically captures the failure load. Within the bottom 10 cm of the web, the subdomain and average thickness measurements should be identified along this area. Furthermore, identification of these subdomains can be facilitated by LiDAR implementation and weighted average techniques. In any case, a generalized average along the whole web bottom should be avoided.

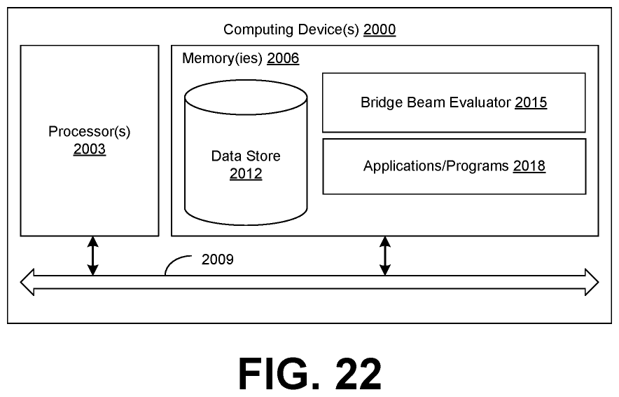

With reference next to FIG. 22, shown is a schematic block diagram of a computing device 2000. In some embodiments, among others, the computing device 2000 may represent one or more computing devices (e.g. a smartphone, tablet, computer, etc.). Each computing device 2000 includes at least one processor circuit, for example, having a processor 2003 and a memory 2006, both of which are coupled to a local interface 2009. To this end, each computing device 2000 may comprise, for example, at least one server computer or like device, which can be utilized in a cloud-based environment. The local interface 2009 may comprise, for example, a data bus with an accompanying address/control bus or other bus structure as can be appreciated.

In some embodiments, the computing device 2000 can include one or more network interfaces. The network interface may comprise, for example, a wireless transmitter, a wireless transceiver, and/or a wireless receiver (e.g., Bluetooth®, Wi-Fi, Ethernet, etc.). The network interface can communicate with a remote computing device using an appropriate communications protocol. As one skilled in the art can appreciate, other wireless protocols may be used in the various embodiments of the present disclosure.

Stored in the memory 2006 are both data and several components that are executable by the processor 2003. In particular, stored in the memory 2006 and executable by the processor 2003 are at least one bridge beam estimator application 2015 and potentially other applications and/or programs 2018. Also stored in the memory 2006 may be a data store 2012 and other data. In addition, an operating system may be stored in the memory 2006 and executable by the processor 2003.

It is understood that there may be other applications that are stored in the memory 2006 and are executable by the processor 2003 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 2006 and are executable by the processor 2003. In this respect, the term “executable” means a program or application file that is in a form that can ultimately be run by the processor 2003. Examples of executable programs may be, for example, a compiled program that can be translated into machine code in a format that can be loaded into a random access portion of the memory 2006 and run by the processor 2003, source code that may be expressed in proper format such as object code that is capable of being loaded into a random access portion of the memory 2006 and executed by the processor 2003, or source code that may be interpreted by another executable program to generate instructions in a random access portion of the memory 2006 to be executed by the processor 2003, etc. An executable program may be stored in any portion or component of the memory 2006 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 1006 is defined herein as including both volatile and nonvolatile memory and data storage components. Volatile components are those that do not retain data values upon loss of power. Nonvolatile components are those that retain data upon a loss of power. Thus, the memory 2006 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 2003 may represent multiple processors 2003 and/or multiple processor cores and the memory 1006 may represent multiple memories 2006 that operate in parallel processing circuits, respectively, such as multicore systems, FPGAS, GPUs, GPGPUs, spatially distributed computing systems (e.g., connected via the cloud and/or Internet). In such a case, the local interface 2009 may be an appropriate network that facilitates communication between any two of the multiple processors 2003, between any processor 2003 and any of the memories 2006, or between any two of the memories 2006, etc. The local interface 2009 may comprise additional systems designed to coordinate this communication, including, for example, performing load balancing. The processor 2003 may be of electrical or of some other available construction.

Although the bridge beam estimator application 2015 and other applications/programs 2018, described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

Also, any logic or application described herein, including the bridge beam estimator application 1215 and other applications/programs 2018, that comprises software or code can be embodied in any non-transitory computer-readable medium for use by or in connection with an instruction execution system such as, for example, a processor 2003 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the bridge beam estimator application 2015 and other applications/programs 2018, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 2000, or in multiple computing devices in the same computing environment. Additionally, it is understood that terms such as “application,” “service,” “system,” “engine,” “module,” and so on may be interchangeable and are not intended to be limiting.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. A method, comprising:
obtaining point cloud data for opposite sides of a bridge beam comprising a plurality of registration objects affixed at defined locations on the bridge beam, the point cloud data comprising data collected by multiple scans of regions of the bridge beam, the point cloud data aligned by course registration based upon the plurality of registration objects and subsequent fine registration based upon surface features of the scanned regions;
determining contour maps of the bridge beam based upon the point cloud data;
identifying thicknesses of the bridge beam from the contour maps; and
determining failure load of the bridge beam based at least in part upon the thicknesses and the contour maps.

2. The method of claim 1, wherein the course registration of the data collected by multiple scans is based upon at least four registration objects.

3. The method of claim 2, wherein the subsequent fine registration is based upon feature size, feature shape, texture pattern, or a combination thereof.

4. The method of claim 1, wherein the thicknesses are determined based upon a point-to-surface distance.

5. The method of claim 4, wherein the point-to-surface distance is determined using principal component analysis.

6. The method of claim 1, comprising generating a corrosion contour and a corrosion heat map of at least a portion of the bridge beam based upon the thicknesses of the bridge beam.

7. The method of claim 1, wherein the point cloud data is obtained using LiDAR measurements of the bridge beam.

8. The method of claim 7, wherein the LiDAR measurements are taken of opposite sides of a corroded end of the bridge beam.

9. The method of claim 1, wherein the failure load is further based upon an average remaining web thickness of the bridge beam.

10. The method of claim 9, wherein the average remaining web thickness is based upon the distance from outer face of the flange to web toe fillet.

11. A system for bridge beam condition evaluation, comprising:
at least one computing device comprising processing circuitry, the at least one computing device configured to at least:
determine contour maps of a bridge beam based upon point cloud data for opposite sides of the bridge beam, the point cloud data aligned by course registration based upon a plurality of registration objects affixed at defined locations on the bridge beam and subsequent fine registration based upon surface features of the scanned regions;
identify thicknesses of the bridge beam from the contour maps; and
determine failure load of the bridge beam based at least in part upon the thicknesses and the contour maps.

12. The system of claim 11, wherein the course registration of the data collected by multiple scans is based upon at least four registration objects.

13. The system of claim 12, wherein the subsequent fine registration is based upon feature size, feature shape, texture pattern, or a combination thereof.

14. The system of claim 11, wherein the thicknesses are determined based upon a point-to-surface distance.

15. The system of claim 14, wherein the point-to-surface distance is determined using principal component analysis.

16. The system of claim 11, wherein the at least one computing device is configured to generate a corrosion contour and a corrosion heat map of at least a portion of the bridge beam based upon the thicknesses of the bridge beam.

17. The system of claim 11, wherein the point cloud data is obtained for the opposite sides of the bridge beam using LiDAR measurements of the bridge beam.

18. The system of claim 17, wherein the LiDAR measurements are taken of opposite sides of a corroded end of the bridge beam.

19. The system of claim 11, wherein the failure load is further based upon an average remaining web thickness of the bridge beam.

20. The system of claim 19, wherein the average remaining web thickness is based upon the distance from outer face of the flange to web toe fillet.
